(19) United States
(12) Patent Application Publication
(10) Pub. No.: US 2015/0241730 A1
(43) Pub. Date: Aug. 27, 2015

(54) ILLUMINATION DEVICE, DISPLAY DEVICE, AND TELEVISION RECEIVING DEVICE

(71) Applicant: SHARP KABUSHIKI KAISHA, Osaka (JP)

(72) Inventor: Kazuya Kondoh, Osaka (JP)

(73) Assignee: Sharp Kabushiki Kaisha, Osaka (JP)

(21) Appl. No.: 14/430,437

(22) PCT Filed: Sep. 27, 2013
(86) PCT No.: PCT/JP2013/076220

§ 371 Date: Mar. 23, 2015

(30) Foreign Application Priority Data
Oct. 4, 2012 (JP) 2012-222299

(51) Int. Cl. G02F 1/1333; H04N 5/655; H04N 5/645; F21V 8/00

(52) U.S. Cl. CPC G02F 1/133308; G02B 6/005; H04N 5/655; H04N 5/645; G02F 2001/13332

(57) ABSTRACT

A backlight device includes: an LED; an optical sheet having an opening at each end on four sides; a support member for supporting the optical sheet; and a locking member for locking each end on the four sides of the optical sheet, the locking member having an penetrating part rising from a support surface and passing through the opening and an extending part extending from the tip of the penetrating part in a direction away from the center position of the optical sheet, the extending part being formed smaller than the opening width of the opening while having a first inclined surface inclining from the tip to the middle portion of the extending part on the side facing the optical sheet so that the extending part increases in diameter from the tip to the middle portion.

### TECHNICAL FIELD

The present invention relates to an illumination device, a display device and a television receiver.

### BACKGROUND ART

Due to liquid crystal panels, which are provided in liquid crystal display devices such as liquid crystal televisions, etc., not emitting light on their own, a backlight device is necessary as a separate illumination device. This type of backlight device is largely classified into a direct-lit backlight device or an edge-lit type backlight device based on the mechanism thereof. In either type of backlight device, i.e., the direct-lit or edge-lit type, an optical sheet, which has a function of exerting optical effects (to facilitate planar light, or the like) on light emitted from a light source, is provided on a display surface side of the display panel.

A configuration is known in which a backlight device having the abovementioned optical sheet has a support member with a frame-shaped support surface that supports ends of the optical sheet. Normally, a pin-shaped locking member is provided on the support surface of such a support member and the optical sheet is locked by inserting this locking member through an opening provided at the end. Document 1 discloses a liquid crystal display device having this type of backlight device.

### RELATED ART DOCUMENT

### Patent Document

Patent Document 1: Japanese Patent Application Laid-Open Publication No. 2002-196312

### Problem to be Solved by the Invention

In recent years, technology using liquid crystal display devices as digital signage has gained popularity. Because of its nature, digital signage is arranged in various directions (vertical placement, horizontal placement, or the like). If a configuration is provided such that only edge end parts of a side of an optical sheet that forms a rectangular shape in a plan view are locked with respect to a housing (support member), and for example, if a liquid crystal display device is arranged in a state where the locked side of the optical sheet is placed at the lower side, the optical sheet may shift downward by self-weight and be disengaged from the locking members. Therefore, in case of the liquid crystal display device used for digital signage, etc., it is necessary to lock respective sides of the optical sheet forming a rectangular shape in a plan view (ends on the four sides) with respect to the housing to prevent the optical sheet from falling from the housing (the support member).

In a backlight device having a configuration where respective sides (ends of the four sides) of an optical sheet forming a rectangular shape in a plan view are locked with respect to the housing, if respective ends of the optical sheet extend outward due to thermal expansion, etc., stress is exerted on the respective sides of the optical sheet locked by locking members. Thus, a configuration in which the tip of a locking member is formed into a claw-shape to facilitate disengagement of an opening arranged at the ends of the optical sheet from the locking members when the ends of the optical sheet extend outward is known. This feature allows extension of the ends of the optical sheet when the ends of the optical sheet extend outward, preventing deflection or destruction, etc. of the optical sheet due to an extension of the optical sheet by thermal expansion or the like. However, if the tip of the locking member has a claw shape, then when the optical sheet that has extended temporarily contracts, an edge of the opening provided in the end of the optical sheet may be caught by the locking member, causing wrinkles or damages in the optical sheet.

### SUMMARY OF THE INVENTION

The feature set forth in the present specification is created in consideration of the situation described above. The present specification aims at providing a feature capable of preventing or suppressing formation of wrinkles, etc. on an optical sheet during contraction of the optical sheet in an illumination device having a configuration in which each end of the optical sheet is locked.

### Means for Solving the Problems

The technology disclosed in the present specification is an illumination device, including:
a light source;
an optical sheet that exerts an optical effect on light emitted from the light source, the optical sheet forming a rectangular shape in a plan view and having an opening in each end on four sides thereof;
a support member having a frame shape and at least having a support surface that supports the ends of the optical sheet; and
locking members that lock the respective ends of the four sides of the optical sheet, each of the locking members including a penetrating part rising from the support surface of the support member toward the optical sheet and passing through the opening therein, and an extending part that bends from a top of the penetrating part and that extends in a direction away from a center position of the optical sheet along a sheet surface thereof, an extension length of the extending part being smaller than an opening width of the opening in the optical sheet along an extension direction of the extending part, the extending part having, on a side facing the optical sheet, an inclined surface that inclines from a tip of the extending part toward a center of the extending part in at least a portion thereof adjacent to the tip.

In an illumination device having a configuration in which each end of an optical sheet is locked by a locking member, the optical sheet expanding due to heat emitted by light from a light source may disengage itself from an penetrating part of a locking member and contract. At that time, an edge of each opening provided at each end of the optical sheet may be caught by the tip of the locking member causing wrinkles or damages in the optical sheet. According to the abovementioned illumination device, however, an inclined surface having the abovementioned shape is provided from the tip to the middle portion of an extending part of the locking member so that when the temporarily extended optical sheet contracts, the edge is brought into contact with the inclined surface and as the optical sheet contracts, the edge smoothly moves according to the shape of the inclined surface while approaching the optical sheet side and the penetrating part side. As a result, the opening of the optical sheet enters the penetrating part of the locking member, and the optical sheet is brought into a locked state again by the locking member. As shown above, in the abovementioned illumination device, i.e., an illumination device (digital signage, etc.) with a configuration in which each end of the optical sheet is locked with respect to a housing, if the optical sheet extends temporarily and contracts, a locked state of each end of the optical sheet is regained, thereby preventing or suppressing formation of wrinkles or damages in the optical sheet. Further, according to the abovementioned illumination device, because an extension length of the extending part is formed smaller than the width of the opening along an extension direction of the extending part of the opening, it is possible to insert the extending part of the locking member through the opening in a state that the sheet surface of the optical sheet is parallel with the support surface and the optical sheet is locked by the locking member in a manufacturing process of the illumination device.

The inclined surface of the extending part may be curved.

According to this configuration, when the optical sheet further contracts in a state where the edge of the opening is in contact with the inclined surface, the edge is moved even more smoothly along with the inclined surface compared with the inclined surface being a flat surface.

The penetrating part may rise at a right angle relative to the support surface of the support member, and the extending part may bend at a right angle relative to the penetrating part

According to this configuration, when the optical sheet further contracts in a state that the edge of the opening is in contact with the inclined surface, the edge is moved even more smoothly according to the inclined surface compared with a configuration in which the extending part bending at an obtuse angle and at a sharp angle with respect to the penetrating part.

A gap between the extending part and the optical sheet may be smaller than a thickness of the optical sheet.

According to this configuration, even if the optical sheet that is locked by the locking member is nearly lifted, because the optical sheet is brought into contact with the extending part immediately, further lifting of the optical sheet can be prevented. Thus, the optical sheet is steadily locked by the locking member.

Tabs that protrude toward the direction away from the center position of the optical sheet may be respectively provided on each end of the four sides of the optical sheet, and the opening may be provided in the respective tabs.

According to this configuration, a configuration in which steps are provided in areas superimposed with an outer periphery of the optical sheet on the support surface excluding areas with the tabs and other members are arranged on the steps, etc., can be realized.

The above-mentioned illumination device may further include a light guide plate having a light-receiving face on at least one end face thereof, and a light-exiting surface on one surface thereof, the light guide plate being arranged such that the light-receiving face opposes a light-emitting surface of the light source and the light-exiting surface faces the sheet surface of the optical sheet with a gap therebetween.

According to this configuration, while realizing an edge-light type illumination device, the optical sheet is separated from the light guide plate, thus, light emitted from the light-exiting surface of the light guide plate that moves toward the optical sheet is preferably diffused between the light guide plate and the optical sheet resulting in satisfactory luminance distribution.

The locking member may be elastically deformable.

According to this configuration, when locking the opening of the optical sheet by the locking member in a manufacturing process of the illumination device, locking can be performed while the locking member is elastically deformed, thus, the optical sheet is easily locked.

In the configuration of the present specification, a display device that includes: a display panel that performs display with light from the illumination device is both novel and useful.

In the display device, the display panel may be disposed on a side opposite to the support surface of the support member with the optical sheet therebetween, and the support member may have a panel support surface that supports ends of the display panel.

According to this configuration, even if a member supporting the display panel is not provided separately, the support member can be used as a member for supporting the display panel.

In the abovementioned display device, the display panel may be disposed at a gap from the optical sheet by being supported by the panel support surface.

If the display panel is arranged on the optical sheet in a layered form, the sheet surface of the optical sheet is pressed by the plate surface of the display panel, leading to deflection of the optical sheet. According to the abovementioned configuration, the optical sheet and the display panel are arranged separately, thus, preventing the deflection of the optical sheet caused by the display panel.

In the configuration of the present specification, the display device further having a liquid crystal panel having liquid crystal is both novel and useful. A television receiver including the display device is also novel and useful.

### Effects of the Invention

According to the features set forth in the present specification, in the illumination device having a configuration in which each end of the optical sheet is locked, wrinkles or the like can be prevented or suppressed from being formed on the optical sheet during contraction of the optical sheet.

### BRIEF DESCRIPTION OF THE DRAWINGS

FIG. 1 is an exploded perspective view of digital signage DS according to Embodiment 1.

FIG. 2 is an exploded perspective view of a liquid crystal display device 10.

FIG. 3 is a cross sectional view that illustrates a cross section along a short side direction of a liquid crystal device 10.

FIG. 4 is a cross sectional view that illustrates main parts of a liquid crystal display device 10.

FIG. 5 is a plan view of a frame 14 to which an optical sheet 18 is locked when viewed from the front side.

FIG. 6 is an enlarged perspective view of a locking member 15 with an optical sheet 18 in a locked state when viewed from the front side.

FIG. 7 is a cross sectional view of a locking member 15 with an optical sheet 18 in a locked state.

FIG. 8 is a cross sectional view of a locking member 15 with an optical sheet 18 in a contracted state according to a first inclined surface 15b1 of a locking member 15.

FIG. 9 is a cross sectional view of a locking member 115 in Embodiment 2 with an optical sheet 118 in a locked state.

FIG. 10 is a cross sectional view of a locking member 215 in Embodiment 3 with an optical sheet 218 in a locked state.

FIG. 11 is an exploded perspective view of a television receiver in Embodiment 4.

### DETAILED DESCRIPTION OF EMBODIMENTS

### Embodiment 1

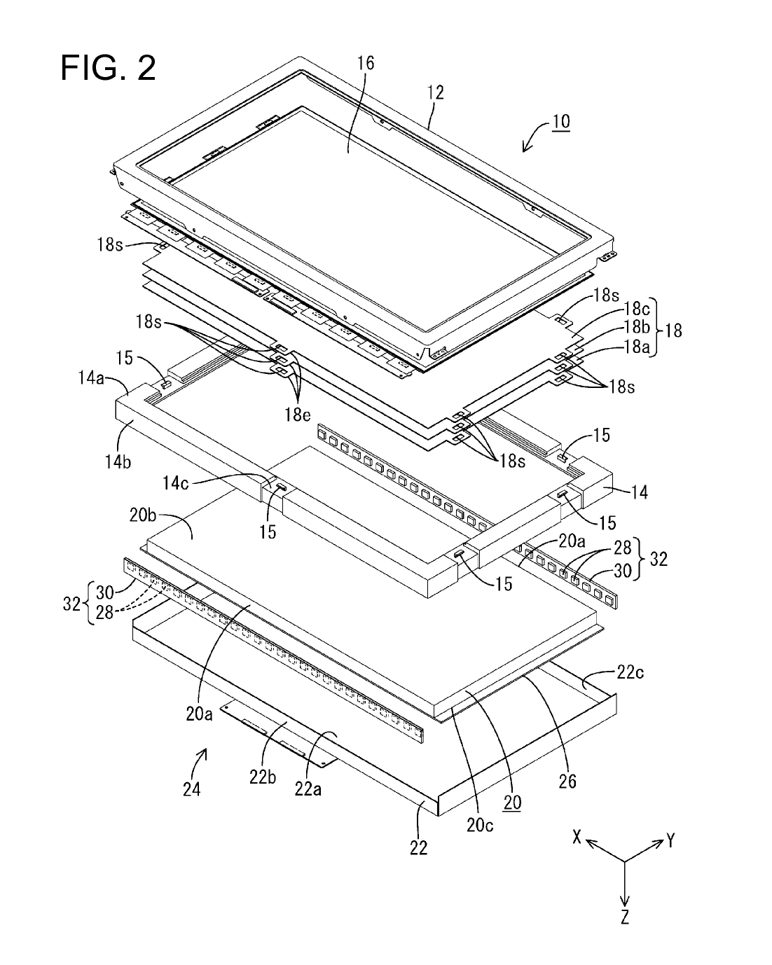

Embodiment 1 will be explained in detail with reference to figures. In this embodiment, digital signage DS is described as an example. Here, parts of the respective drawings illustrate X-axis, Y-axis and Z-axis, which are all common directions in the respective drawings. The Y-axis direction corresponds to a vertical direction, and the X-axis direction corresponds to a horizontal direction. Unless otherwise specified, the description of upper and lower side uses the vertical direction as a reference and the upper side is defined as the front side of a liquid crystal display device 10, and the lower side is defined as the rear side of the liquid crystal display device 10 in FIGS. 2 to 4.

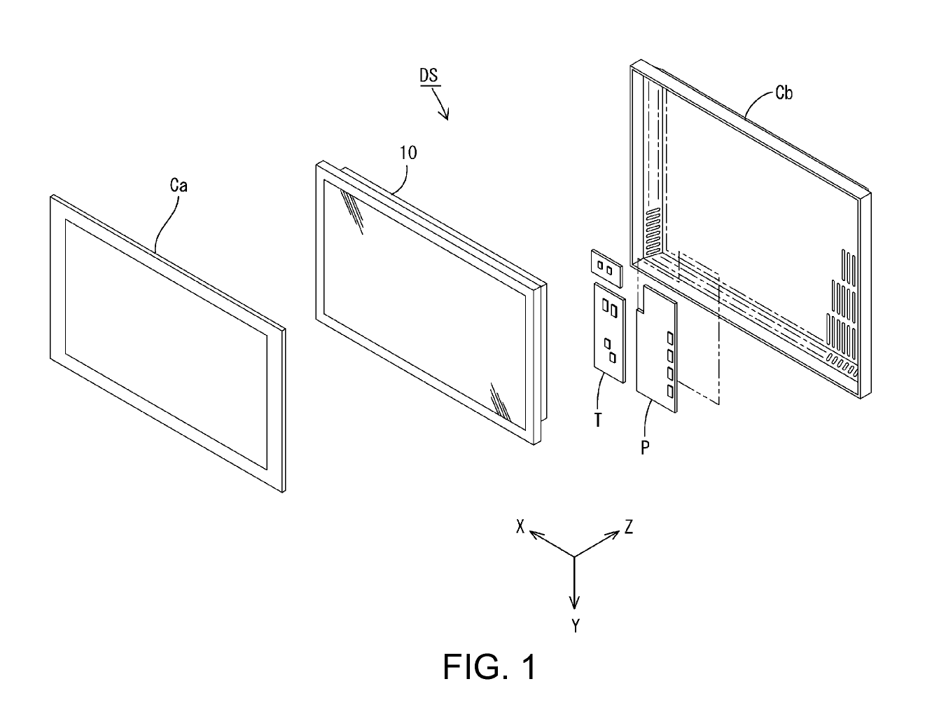

Digital signage DS includes a liquid crystal display device (an example of a display device) 10, both front and rear cabinets Ca and Cb that house the liquid crystal display device 10 in a sandwiching manner, a power source P and a tuner T. The digital signage DS is not limited to the direction shown in FIG. 1 and is arranged in various directions for usage. For example, the upper side part of the digital signage DS shown in FIG. 1 can be placed at the lower side for usage and the right or left side part of the digital signage DS shown in FIG. 1 can be placed at the lower side for usage. The liquid crystal display device 10, which generally forms a horizontally-long rectangular shape, is provided with a liquid crystal panel 16, which is a display panel, and a backlight device as an external light source (an example of an illumination device) 24 and these components are integrally held together by a frame-shaped bezel 12 or the like. In the liquid crystal display device 10, the liquid crystal panel 16 is assembled such that a display surface that is capable of displaying an image faces the front side.

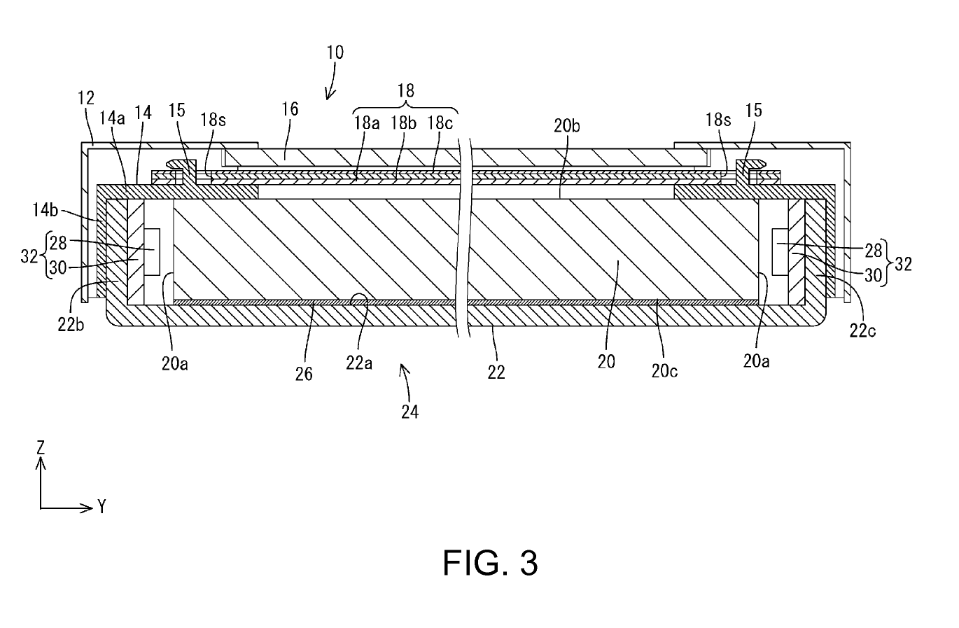

As shown in FIG. 2 and FIG. 3, the bezel 12, which is made of a metal having excellent rigidity such as stainless steel, is parallel with the liquid crystal panel 16 and constituted of a part that forms a substantially frame-shaped plate surface in plan view and a tubular plate surface that forms a substantially short tubular shape extending from the outer peripheral end of the part forming the substantially frame-shaped plate surface to the back side. The bezel 12 extends along ends of the display surface of the liquid crystal panel 16 and holds the liquid crystal panel 16 by pressing the ends from the front side. Therefore, the bezel 12 constitutes an exterior appearance of the front side of the liquid crystal display device 10.

Now, the liquid crystal panel 16 is discussed. The liquid crystal panel 16 is constituted of a pair of transparent (having a high translucency) glass substrates that are bonded with a prescribed gap and a liquid crystal layer (not shown) that is sealed between the glass substrates. A switching element (TFT, for example) connecting to a source wire and a gate wire that are orthogonal to one another, a pixel electrode connecting to the switching element, an alignment film, or the like are provided on one side of the glass substrate, and a color filter to which respective colored portions such as R (red), G (green) and B (blue), etc. are arranged in a prescribed sequence, a counter electrode, an alignment film, or the like are provided on the other glass substrate. Image data and various control signals that are necessary for displaying images are supplied to the source wire, the gate wire, and the counter electrode, etc., from a driver circuit substrate which is not shown. Moreover, polarizing plates (not shown) are arranged at the outside of both glass substrates.

Next, a configuration of the backlight device 24 is discussed. As shown in FIG. 2 and FIG. 3, the backlight device 24 includes a substantially boxed-shape chassis 22 that opens toward the front side (light-exiting side; liquid crystal panel 16 side), a frame arranged on the front side of the chassis 22 (an example of a support member) 14, and an optical sheet 18 arranged so as to cover the opening of the frame 14. Further, a pair of LED units 32 and 32 and a light guide plate 20 that guides light from the LED units 32 to the optical sheet 18 (the liquid crystal panel 16) are housed in the chassis 22. Both side faces of long sides of the light guide plate 20 (light-receiving faces) 20a are arranged in a position facing the respective LED units 32 and guide light emitted from the LED units 32 to the liquid crystal panel 16 side. On the front side of the light guide plate 20, the optical sheet 18 is arranged so as to be separated from the surface (light-exiting surface 20b) of the light guide plate 20. In the backlight device 24 according to the present embodiment, a so-called edge-lit method (side-lit method) is adopted in which the light guide plate 20 and the optical sheet 18 are arranged immediately below the liquid crystal panel 16 and the LED units 32, which are the light sources, are arranged at the side end of the light guide plate 20. Respective component parts of the backlight device 24 are discussed in detail below.

The chassis 22 is composed of metal plates, such as aluminum plates and electrogalvanized steel sheets (SECC) and constituted of a bottom plate 22a that forms a horizontally-long rectangular shape in a similar manner to the liquid crystal panel 16, side plates 22b and 22c which rise from respective outer edges of both long sides of the bottom plate 22a, and side plates which rise from respective outer edges of both short sides of the bottom plate 22a as shown in FIG. 2 and FIG. 3. The long side direction of the chassis 22 (the bottom plate 22a) corresponds to the X-axis direction (horizontal direction) and the short side direction corresponds to the Y-axis direction (vertical direction). The bottom plate 22a extends along the light guide plate 20 and a reflective sheet 26 housed in the chassis 22 and supports these components from the back side. At the outside of the back side of the bottom plate 22a, a control substrate (not shown) for supplying signals for driving of the liquid crystal panel 16 is attached. Further, similarly to the abovementioned control substrate, other substrates, such as an LED drive substrate (not shown) for supplying drive power to the LED units 32, are attached on the bottom plate 22a.

The LED unit 32 has a configuration in which the LEDs 28 are arranged in a row on a rectangular shaped LED substrate 30 which is made of resin. As shown in FIG. 2 and FIG. 3, the LED substrate 30 forms an elongated plate shape that extends along the long side direction (X-axis direction) of the chassis 22 and at the same time is housed in the chassis 22 such that the plate surface is parallel to the X-axis and Z-axis directions, i.e., in a position that is orthogonal to the plate surfaces of the liquid crystal panel 16 and the light guide plate 20. The LED substrates 30 are arranged in a form that are adjacent to both end faces (the light-receiving faces) of the long sides of the light guide plate 20 while keeping a prescribed gap with respect to the light guide plate 20, and are attached to inner surfaces of both side plates 22b and 22C of the long side of the chassis 22. The LED 28 are mounted the surface LED substrate 30 facing the light guide plate 20 and this is a mounting surface 30a of the LEDs 28. A plurality of the LEDs 28 are arranged in parallel in a row (linearly) in prescribed intervals along the length direction (X-axis direction) on the mounting surface 30a of the LED substrate 30. The interval between adjacent LEDs 28 in the X-axis direction, i.e., an array pitch of the LEDs 28 is approximately equal.

The LED 28 has a configuration in which an LED chip (not shown) fixed on the LED substrate 30 are sealed by a resin material. The LED chip mounted on the substrate part has one kind of main emission wavelength and specifically, monochromatically emits light of a blue color. On the other hand, a phosphor is dispersedly mixed in the resin material sealing the LED chip that emits a prescribed color when excited by blue light emitted from the LED chip and generally, white light is emitted. As a phosphor, for example, a combination that is made as appropriate from a yellow phosphor emitting yellow light, a green phosphor emitting green light, and red phosphor emitting red light can be used or any one of the single phosphors can be used. This LED 28 is a top surface emitting type in which a light emitting surface is opposite to the mounted surface on the LED substrate 30.

The light guide plate 20 is composed of a synthetic resin material (for example, an acrylic resin such as PMMA or a polycarbonate resin) that has a sufficiently higher reflective index than air and is almost transparent (excellent translucency). As shown in FIG. 2, similarly to the liquid crystal panel 16 and the chassis 22, the light guide plate 20 forms a horizontally-long rectangular shape in plan view as well as a plate-like shape that is thicker than the optical sheet 18, and the long side direction on the plate surface corresponds to the X-axis direction, the short side direction corresponds to the Y-axis direction, and the plate thickness direction which is orthogonal to the plate surface corresponds to the Z-axis direction. As shown in FIG. 2 and FIG. 3, the light guide plate 20 is provided between the pair of the LED units 32 and 32 such that the light-exiting surface 20b, which is the main plate surface (a plate surface on the front side), faces the optical sheet 18 side and an opposite surface 20c, which is a plate surface on the side opposite (a plate surface on the back side) to the light-exiting surface 20b. The light-exiting surface 20b of the light guide plate 20 faces the reflective sheet 26 side and is supported by the bottom plate 22a of the chassis 22 via the reflective sheet 26. Thus, an arrangement direction of the light guide plate 20 with the LED units 32 corresponds to the Y-axis direction and an arrangement direction of the light guide plate 20 with the optical sheet 18 and the reflective sheet 26 corresponds to the Z-axis direction. The light guide plate 20 has functions of introducing light emitted from each LED unit 32 along the Y-axis direction through the end face of the long sides (the light-receiving face), lifting the light toward the optical sheet 18 side while propagating the light therein and emitting this light from the light-exiting surface 20b.

The reflective sheet 26 has a rectangular sheet shape and is made of a synthetic resin. The surface of the reflective sheet is white in color and has excellent reflecting properties. The reflective sheet 26, of which the long side direction corresponds to the X-axis direction and the short side direction corresponds to the Y-axis direction, is provided between an opposite surface 20c of the light guide plate 20 and the bottom plate 22a of the chassis 22 in a sandwiching manner. The reflective sheet 26 has a reflecting surface on the front side and this reflecting surface contacts with the opposite surface 20c of the light guide plate 20, enabling the reflective sheet 26 to reflect light escaped from the LED units 32 or the opposite surface 20c of the light guide plate 20 to the reflecting surface side.

The optical sheet 18 is flexible and forms a horizontally-long rectangular shape in plan view that is similar to the liquid crystal panel 16 and the bottom plate 22a of the chassis 22 as shown in FIG. 2. The optical sheet 18 is formed by stacking a diffusion sheet 18a, a lens sheet 18b, and a reflection type polarizing plate 18c in this order from the light guide plate 20 side. Intermediately arranged between the liquid crystal panel 16 and the light guide plate 20, the optical sheet 18 transmits light emitted from the light guide plate 20 and emits the transmitted light toward the liquid crystal panel 16, while exerting a prescribed optical effect thereon. The optical sheet 18 is arranged in a state having a slight gap between the liquid crystal panel 16. Further, the ends of the optical sheet 18 are made one size larger than the opening surrounded by an inner edge of a frame-shaped part 14a of a frame 14, which is discussed below, and an outer edge part is supported on the frame-shaped part 14a. As shown in FIG. 3, with this configuration, the frame 14 divides space formed between the LED units 32 and the light guide plate 20 from the end portion of the optical sheet 18. Although the optical sheet 18 is approximately equal in size to the liquid crystal panel 16 in plan view, as shown in FIG. 2 and FIG. 3, a plurality of tabs 18e that extend outward beyond the outer end of the liquid crystal panel 16 are provided on the end of the optical sheet 18. The tabs 18e are discussed in more detail below.

The frame 14, which is made of a synthetic resin such as plastic, is parallel to the optical sheet 18 and the light guide plate 20 (the liquid crystal panel 16) and constituted of the substantially frame-like frame-shaped part 14a in plan view and a tubular frame part 14b that forms a substantially short tubular shape and protrudes toward the back side from the outer peripheral of the frame-shaped part 14a. The frame-shaped part 14a extends along the outer peripheral edge of the light guide plate 20 and is capable of covering nearly the entire periphery of the outer peripheral edge of the light guide plate 20, which is arranged on its back side from the front side. On the other hand, the frame-shaped part 14a is capable of receiving (supporting) the outer peripheral edge of the optical sheet 18, which is arranged on its front side from the back side. Therefore, the frame-shaped part 14a is arranged intermediately between the optical sheet 18 and the light guide plate 20. Further, a pair of long sides in the frame-shaped part 14a collectively cover the end portion of the light-receiving face 20a side of the light guide plate 20 and the LED units 32 from the front side. The tubular frame part 14b is fittingly attached on the outer surfaces of the side plates 22b and 22c of the chassis 22. The outer surface of the tubular frame part 14b is arranged so as to contact with the inner surface of the tubular plate surface of the abovementioned bezel 12.

In the frame-shaped part 14a, as shown in FIG. 2 and FIG. 3, a plurality of steps are provided in the inner edge portion that extends outward from the back side to the front side. Specifically, the frame-shaped part 14a is composed of three step surfaces. The surface of the higher step supports the bezel 12 by contacting the inner surface of the frame-shaped plate surface of the abovementioned bezel 12. The surface of the intermediate step is provided at a height positioned at a forward side positioned more towards the front than the surface of the optical sheet 18, which is a panel support surface 14d that supports the outer edge of the liquid crystal panel 16. With this configuration, the liquid crystal panel 16 and the optical sheet 18 are separately supported by the frame 14 with gaps therebetween. The surface of the lower step supports the outer edge portion of the optical sheet 18. Further, a plurality of extending surfaces 14c (an example of the support surface) are provided on the surface of the lower step, extending toward the outside of the frame-shaped part 14a at the same height as this surface (the same position in the Z-axis direction) and open to the outside of the frame-shaped part 14a. On each extending surface 14c, a hook-shape locking member 15 that locks the optical sheet 18 is provided. The locking member 15 is discussed in more detail below.

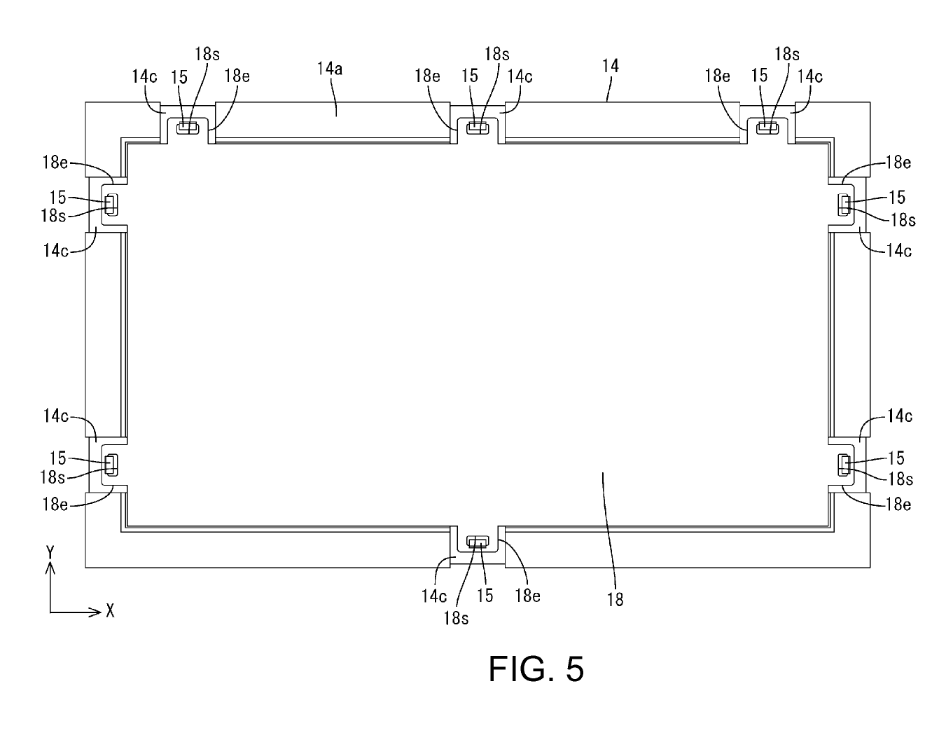

Next, the configuration of the tab 18e of the optical sheet 18, the configuration of the locking member 15, and the locking modes of the optical sheet 18 by the locking member 15, which are main parts of the present embodiment, will be explained. As shown in FIG. 5, a tab 18e having a rectangular shape in plan view convexly extending in a direction away from the center position of the optical sheet 18 is provided at each end part of the four sides of the optical sheet 18. This tab 18e is provided as the same arrangement, shape and size with respect to each of three sheet-shaped members, 18a, 18b and 18c that constitute the optical sheet 18. One tab 18e is provided on the end of one side (the end located on the left side in FIG. 3) of the long sides of the optical sheet 18, three are provided on the end of the other side (the end located on the right side in FIG. 3) of the long sides of the optical sheet 18 and two each are provided on the both ends of the short sides of the optical sheet 18 (see FIG. 5). Each tab 18e is provided at the corresponding position to the extending surface 14c on the frame-shaped part 14a and supported by the extending surface 14c by being arranged on the extending surface 14c.

In each tab 18e, an opening 18s that passes through its thickness direction (Z-axis direction) is provided, respectively. As shown in FIG. 5, each opening 18s forms a substantially rectangular shape in plan view. Further, this opening 18s is also provided as the same arrangement, shape and size with respect to the three sheet-shaped members 18a, 18b, and 18c that constitute the optical sheet 18.

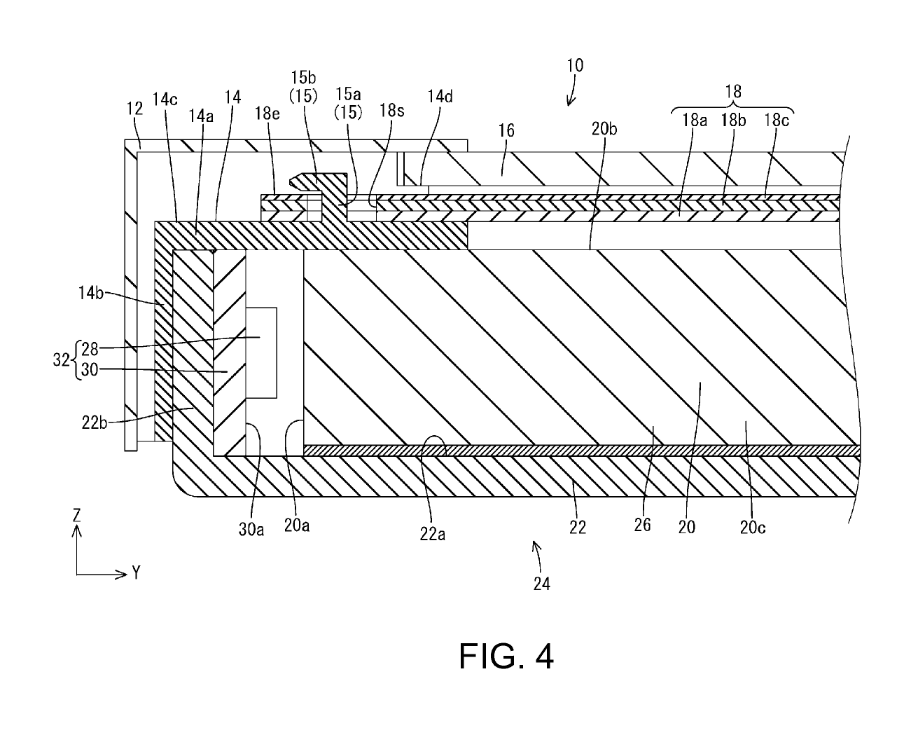

As shown in FIG. 4 and FIG. 5, the hook-shaped locking member 15 is provided on each extending surface 14c on the frame-shaped part 14a, respectively. The locking member 15 is elastically deformable and constituted of an penetrating part 15a rising from the extending surface 14c to the front side, and an extending part 15b bending from the tip of the penetrating part 15a. The penetrating part 15a that constitutes a portion of the locking member 15 forms an elongated plate shape along the ends of the optical sheet 18 in plan view, extends to the front side forming right angle relative to each extending surface 14c and passes through the opening 18s provided on each tab 18e. The penetrating part 15a passes through the opening 18s that is provided in each tab 18e in a separated state from the edges of the opening 18s. Further, as shown in FIG. 4, the penetrating part 15a extends its tip to the height between the panel support surface 14d on the frame-shaped part 14a and the surface of the higher step on which the bezel 12 is supported. Therefore, even if the tab 18e of the optical sheet 18 moves in the sheet surface direction (X-Y plane direction) and the penetrating part 15a is brought into contact with the edge of the opening 18s provided on the tab 18e, further movement of the tab 18e in the sheet surface direction is prevented. Thus, movement of the optical sheet 18 in the sheet surface direction (X-Y plane direction) is regulated by the penetrating part 15a.

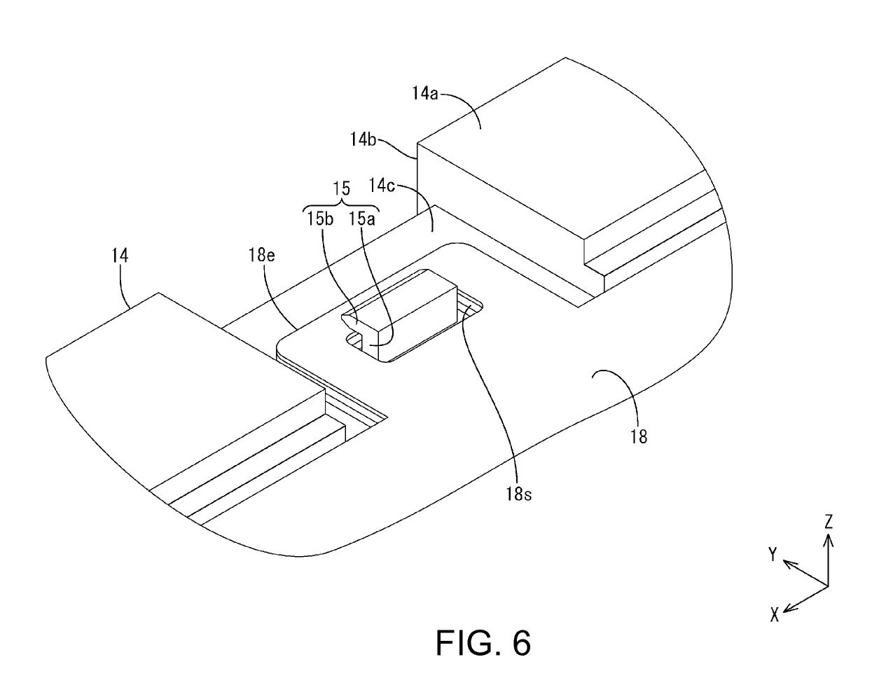

The extending part 15b constituting the locking member 15 is bent from the tip of the penetrating part 15a at a right angle and extends in plate shape. The extending part 15b extends along the sheet surface of the optical sheet 18 (specifically, along the Y-axis direction) in a direction away from the center position of the optical sheet 18. The tip of the extending part 15b is located on a further forward side (the inside) than the tip of the tab 18e of the optical sheet 18 and on a further outward side than the edge of the outside of the opening 18s of the tab 18e. Thus, the tip of the extending part 15b is located above the sheet surface of the tab 18e. Therefore, even if the tab 18e of the optical sheet 18 is lifted toward the front side (the upper side), the tab 18e is brought into contact with the extending part 15b, preventing the tab 18e from being lifted up further. For this reason, the movement of the optical sheet 18 in the thickness direction of the optical sheet 18 (Z-axis direction) is regulated by the extending part 15b. As shown above, the movement of the tab 18e of the optical sheet 18 in the direction of the X-Y plane direction or the Z-axis direction is regulated by the locking member 15 (see FIG. 6). Thus, it can be said that the optical sheet 18 is locked by the locking member 15 with respect to the frame 14.

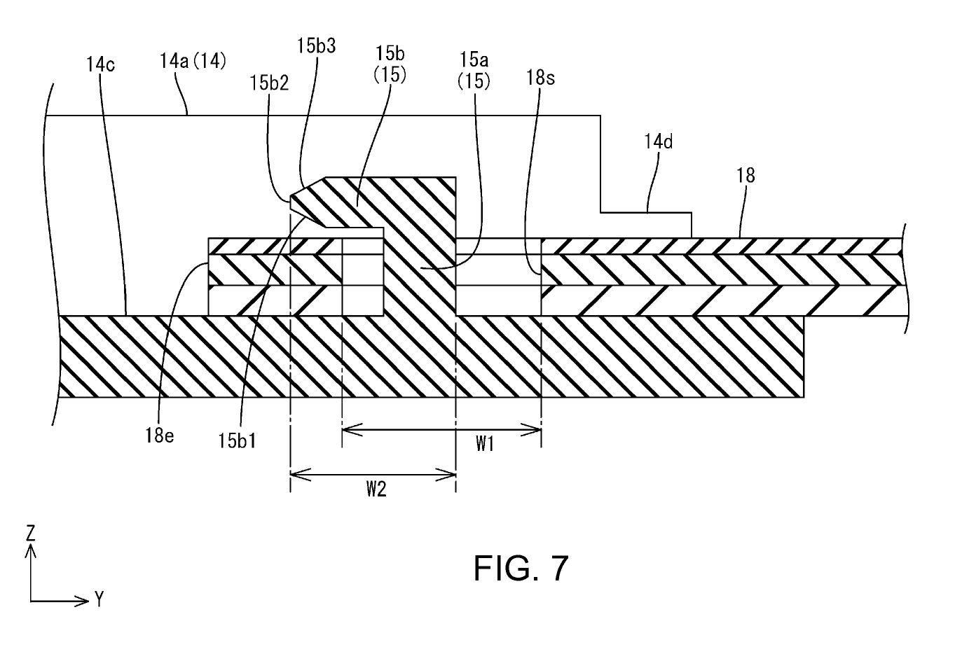

The shape of the tip of the extending part 15b is discussed in detail. As shown in FIG. 7, a first inclined surface 15b1 (an example of the inclined surface) inclining from the tip to the middle portion of the extending part 15b is provided on the side facing the optical sheet 18 (the back side) of the tip of the extending part 15b. The first inclined surface 15b1 is a flat surface that inclines from the front side to the back side. Further, a second inclined surface 15b3 inclining from the tip to the middle portion of the extending part 15b is provided on the opposite side of the side facing the optical sheet 18 of the tip of the extending part 15b (the front side). This second inclined surface 15b3 is a flat surface that inclines from the back side to the front side. The extending part 15b has a shape increasing in diameter from the tip to the middle portion by the first inclined surface 15b1 and the second inclined surface 15b3. Moreover, a tip surface 15b2 parallel to the plate surface of the tubular frame part 14b (the plate surface of the side plates of the chassis 22, 22b and 22c) is provided between the first inclined surface 15b1 and the second inclined surface 15b3, i.e. at the foremost tip of the extending part 15b. Here, the distance between the tip of the extending part 15b and the optical sheet 18 is smaller than the thickness of the optical sheet 18.

As shown in FIG. 7, an extension length W2 of the extending part 15b constituting the locking member 15 is smaller than an opening width W1 along the extension direction of the extending part 15b (the Y-axis direction) in the opening 18s provided on the tab 18e. Thus, it is possible to pass the penetrating part 15a of the locking member 15 through the opening 18s of the tab 18e in a state being parallel to the extension surface 14c of the frame-shaped part 14a without catching the extending part 15b of the locking member 15 at the opening 18s of the tab 18e.

Next, a procedure of having the optical sheet 18 locked at each locking member 15 provided on the frame 14 in a manufacturing process of the backlight device 24 is discussed. When locking the optical sheet 18 at each locking member 15, the optical sheet 18 is brought closer to the frame-shaped part 14a from the front side of the frame-shaped part 14a in a state of the sheet surface of the optical sheet 18 being parallel to the extension surface 14c of the frame-shaped part 14a, and the penetrating part 15a of the locking member 15 is passed through the opening 18s of the tab 18e with respect to the locking member 15 provided on one side of the four sides of the frame-shaped part 14a. At this time, as described above, the penetrating part 15a can pass through the opening 18s without catching the extending part 15b of the locking member 15 at the opening 18s of the tab 18e and the opening 18s can be locked by the locking member 15. Next, the optical sheet 18 is shifted toward one of the three sides of the four sides of the frame-shaped part 14a different from the side locked by the locking member 15. By doing this, the locking member provided on a side of the four sides of the frame-shaped part 14a different from the side the optical sheet 18 is locked can be superimposed with the opening 18s of the tab 18e corresponding to the locked part 15 in plan view.

Next, the superimposed locking member 15 and the opening 18s of the tab 18e are locked by a similar procedure. Using the similar procedure, each end of the four sides of the optical sheet 18 is locked with respect to the locking member 15 provided respectively on each side of the frame-shaped part 14a by shifting to a side of the four sides of the frame-shaped part 14a the optical sheet 18 is not locked. By doing this, the optical sheet 18 can be locked against the frame 14. Because the optical sheet 18 locked in this manner is locked at each end of the four sides against the frame 14, even if the backlight device 24 is arranged such that any one of the four ends of the optical sheet 18 is placed at the lower side, it is difficult to detach the optical sheet 18 from the frame 14. Thus, the backlight device 24 according to the present embodiment can preferably be used as an illumination device for digital signage DS.

In the backlight device 24 according to the present embodiment, the optical sheet may expand from heat, etc., generated by the LED 28. If the optical sheet 18 expands from heat, each end of the optical sheet 18 may extend outward (in a direction away from the center position of the optical sheet 18) and each end of the optical sheet 18 may be warped toward the front side by reflection. In such a case, the tab 18e of the optical sheet 18 may shift outward and at the same time the tab 18e may lift from the extension surface 14c of the frame-shaped part 14a, leading to a state in which the tab 18e is easily disengaged from the locking member 15. Subsequently, if the optical sheet 18 shifts into a low temperature state, each end of the optical sheet 18 contracts inward (in a direction approaching the center position of the optical sheet 18) and each warped end of the optical sheet 18 regains its original state.

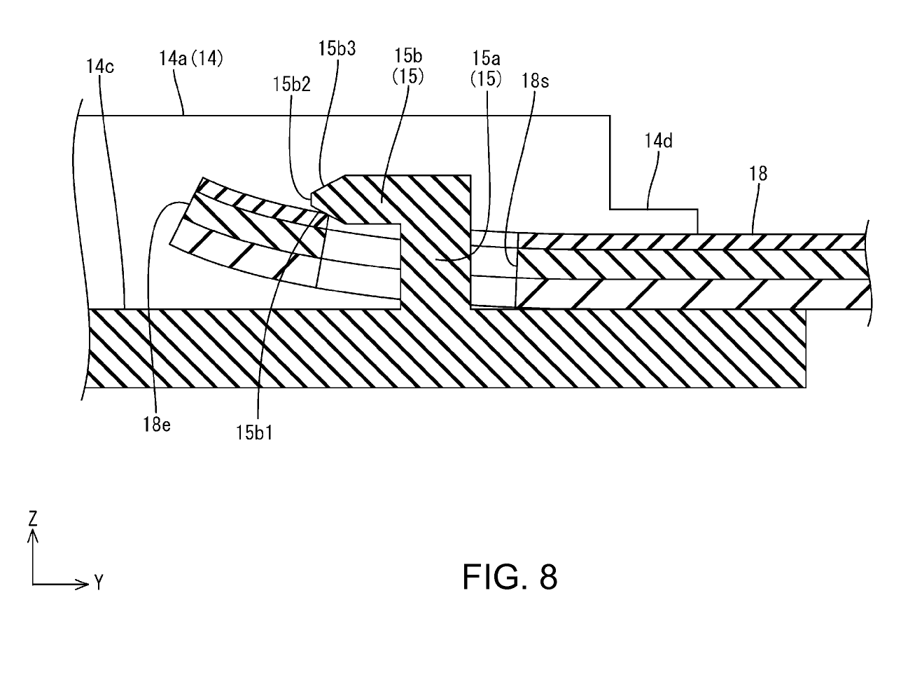

At this time, the edge of the opening 18s provided on the tab 18e of the optical sheet 18 may be caught at the tip of the extending part 15b of the locking member 15. As described above, in the present embodiment, because the first inclined surface 15b1 is provided on the tip of the extending part 15b of the locking member 15, the edge of the opening 18s of the tab 18e is brought into contact with the first inclined surface 15b1 when the optical sheet contracts as shown in FIG. 8. Subsequently, the edge of the opening 18s that has been brought into contact with the first inclined surface 15b1 moves according to the first inclined surface 15b1 on the first inclined surface 15b1 as the optical sheet contracts. Thus, the edge of the opening 18s moves smoothly toward the inclining direction of the first inclined surface 15b1, i.e., inward (in a direction approaching the center position of the optical sheet 18) and the back side (in a direction approaching the extension surface 14c of the frame-shaped part 14a). With this, the tab 18e of the optical sheet 18 returns to the same position as a state prior to thermal expansion (a state in which the opening 18s of the tab 18e is securely locked by the locking member 15).

As described above, in a backlight device having a configuration in which each end of the optical sheet 18 is locked by the locking member 15, the optical sheet 18 may extend from heat generated when the LED 28 is lighted and the abovementioned opening 18s may be disengaged from the penetrating part 15a of the locking member 15, subsequently when the LED 28 is turned off, the optical sheet 18 which shifts in a low temperature state may contract, and the edge of each opening 18s provided at each end of the optical sheet 18 may be caught at the tip of the locking member 15 resulting in formation of wrinkles or damages of the optical sheet 18. In the backlight device 24 according to the present embodiment, because the abovementioned inclined surface is formed from the tip of the extending part 15b of the locking member 15 to the middle portion, when the temporarily extended optical sheet contracts, the edge is brought into contact with the first inclined surface 15b1 and as the optical sheet 18 further contracts, the edge smoothly moves according to the shape of the first inclined surface 15b1 while approaching the optical sheet 18 side and the penetrating part 15a side. As a result, the opening 18s of the optical sheet 18 enters the penetrating part 15a of the locking member 15 and the optical sheet 18 is locked again by the locking member 15. Thus, in the backlight device 24 according to the present embodiment, when the optical sheet 18 temporarily expands and then contracts, a state of each end of the optical sheet 18 being locked is regained, thereby preventing or suppressing formation of wrinkles or damages from occurring to the optical sheet 18. Thus, the backlight device 24 according to the present embodiment can be preferably used as an illumination device of digital signage DS having a configuration in which each end of the optical sheet 18 is locked against the frame 14, yet is capable of preventing or suppressing formation of wrinkles and damages from occurring to the optical sheet 18.

Further, in the backlight device 24 according to the present embodiment, the penetrating part 15a rises at a right angle with respect to the extension surface 14c and the extending part 15b is bent at a right angle with respect to the penetrating part 15a. According to this configuration, when the optical sheet 18 contracts further in a state that the edge of the opening 18s is brought into contact with the first inclined surface 15b1, the edge moves smoothly according to the first inclined surface 15b1 compared with a configuration where the extending part 15b bending at an obtuse angle and at a sharp angle with respect to the penetrating part 15a.

Further, in the backlight device 24 according to the present embodiment, the distance between the tip of the extending part 15b and the optical sheet 18 is smaller than the thickness of the optical sheet 18. According to this configuration, even if the optical sheet 18 that is locked by the locking member 15 is nearly lifted from the extension surface 14c, because the optical sheet 18 is brought into contact with the extending part 15b immediately, further lifting of the optical sheet 18 can be prevented. Thus, the optical sheet 18 is steadily locked by the locking member 15.

Further, the backlight device 24 according to the present embodiment is an edge-light type backlight device 24 including the light guide plate 20 in which the light-exiting surface 20b is arranged so as to face and be separated from the sheet surface of the optical sheet 18. According to this configuration, light emitted from the light-exiting surface 20b of the light guide plate 20 that moves toward the optical sheet 18 is preferably diffused between the light guide plate 20 and the optical sheet 18 resulting in satisfactory luminance distribution.

Further, in the backlight device 24 according to the present embodiment, the locking member 15 is elastically deformable. According to this configuration, when locking the opening 18s of the optical sheet 18 by the locking member 15 in a manufacturing process of the illumination device 24, locking can be performed while the locking member 15 is elastically deformed, thus, the optical sheet 18 is easily locked.

Further, in the liquid crystal display device 10 having the backlight device 24 according to the present embodiment, the liquid crystal panel 16 may be arranged separately from the optical sheet 18 by being supported by the panel support surface 14d of the frame 14. If the liquid crystal panel 16 is arrange on the optical sheet 18 in a layered form, the sheet surface of the optical sheet 18 is pressed by the plate surface of the liquid crystal panel 16, leading to deflection of the optical sheet 18. According to the configuration of the present embodiment, the optical sheet 18 and the liquid crystal panel 16 are arranged separately from one another, thus, preventing the deflection of the optical sheet 18 caused by the liquid crystal panel 16.

### Embodiment 2

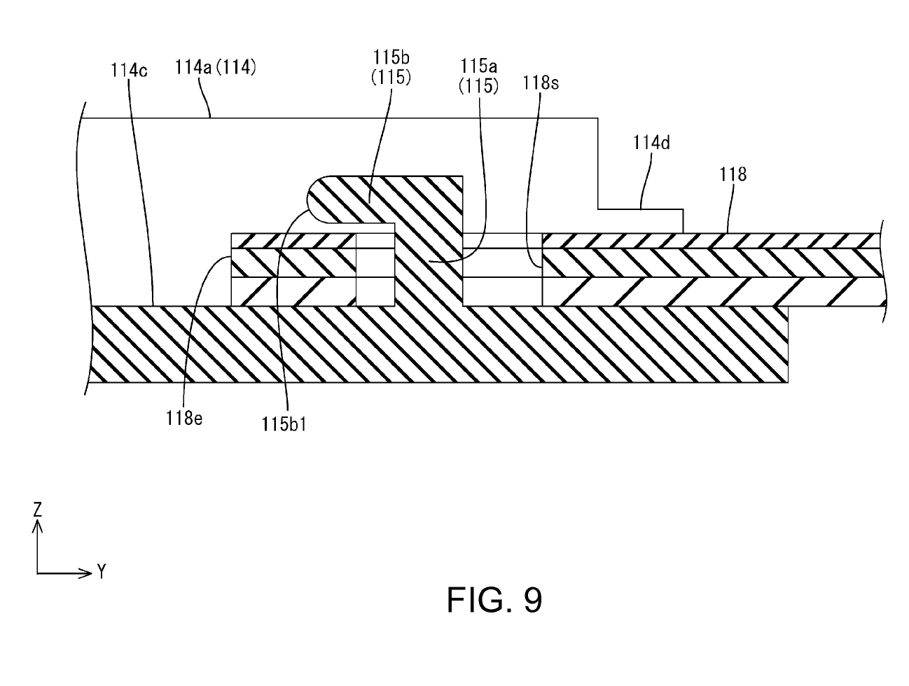

Embodiment 2 will be explained in detail with reference to figures. In Embodiment 2, the tip of an extending part 115b of a locking member 115 differs from that of Embodiment 1. As other configurations are identical to Embodiment 1, explanation of configurations, actions and effects are omitted. In FIG. 9, parts to which 100 are added to their numerical references in FIG. 7 are identical to the parts explained in Embodiment 1.

As shown in FIG. 9, in a backlight device according to Embodiment 2, a curved surface 115b1 (an example of the inclined surface) protruded outward from the tip to the middle portion of an extending part 115b is provided on the tip of the extending part 115b of a locking member 115. This curved surface is arranged on a side facing an optical sheet 118 (the back side) at the tip of the extending part 115b and an opposite side from the side facing the optical sheet 118 (the front side) at the tip of the extending part 115b, respectively. In other words, it can be said that the tip shape of the extending part 115b in Embodiment 2 is a shape that curvature is provided on the first inclined surface 15b1 and the second inclined surface 15b3 of the extending part 15b of Embodiment 1. In Embodiment 2, by forming the tip of the extending part 115b in such a shape, when the optical sheet further contracts in a state in which an edge of an opening 118s is brought into contact with the curved surface 115b1, the edge moves even more smoothly according to the curved surface 115b1 compared with the curved surface 115b1 being a flat surface.

### Embodiment 3

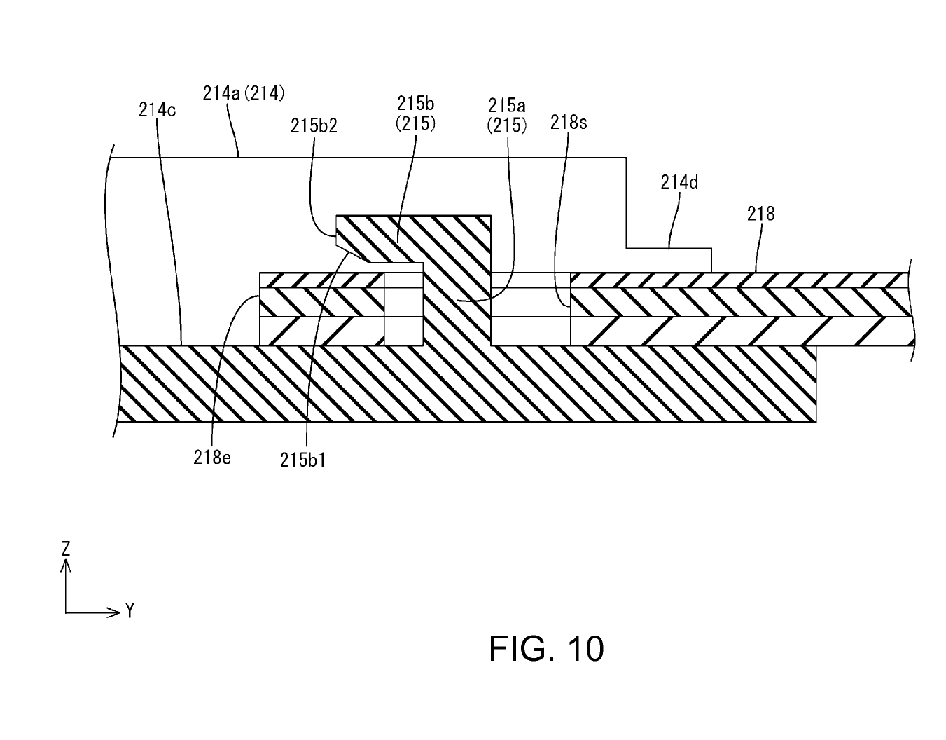

Embodiment 3 will be explained in detail with reference to figures. In Embodiment 3, the tip of an extending part 215b of a locking member 215 differs from that of Embodiment 1. As other configurations are identical to Embodiment 1, explanation of configurations, actions and effects are omitted. In FIG. 10, parts to which 200 are added to their numerical references in FIG. 7 are identical to the parts explained in Embodiment 1.

As shown in FIG. 10, in a backlight device according to Embodiment 3, an inclined surface 215b1 that inclines from the tip to the middle portion of an extending part 215b is provided on a side facing an optical sheet 218 (the back side) at the tip of the extending part 215b. The inclined surface 215b1 is a flat surface inclining from the front side to the back side. The extending part 215b increases in diameter from the tip to the middle portion by this inclined surface 215b1. Further, a planar-shaped tip surface 215b2 is provided at the furthermost tip of the extending part 215b along the thickness direction of the optical sheet 218 (Z-axis direction). Thus, the tip shape of the extending part 215b in Embodiment 3 is identical to the tip shape of the extending part 15b in Embodiment 1 except for the second inclined surface that has been eliminated. Even in such a configuration, when the temporarily extended optical sheet 218 contracts, the edge is brought into contact with the inclined surface 215b1, and as the optical sheet 218 further contracts, the edge moves smoothly according to the shape of the inclined surface 215b1 while approaching the optical sheet 218 side and an penetrating part 215a side. Therefore, when the temporarily extended optical sheet 218 contracts, each end of the optical sheet 218 is returned to a locked state thereby preventing or suppressing formation of wrinkles or damages from occurring to the optical sheet 218.

### Embodiment 4

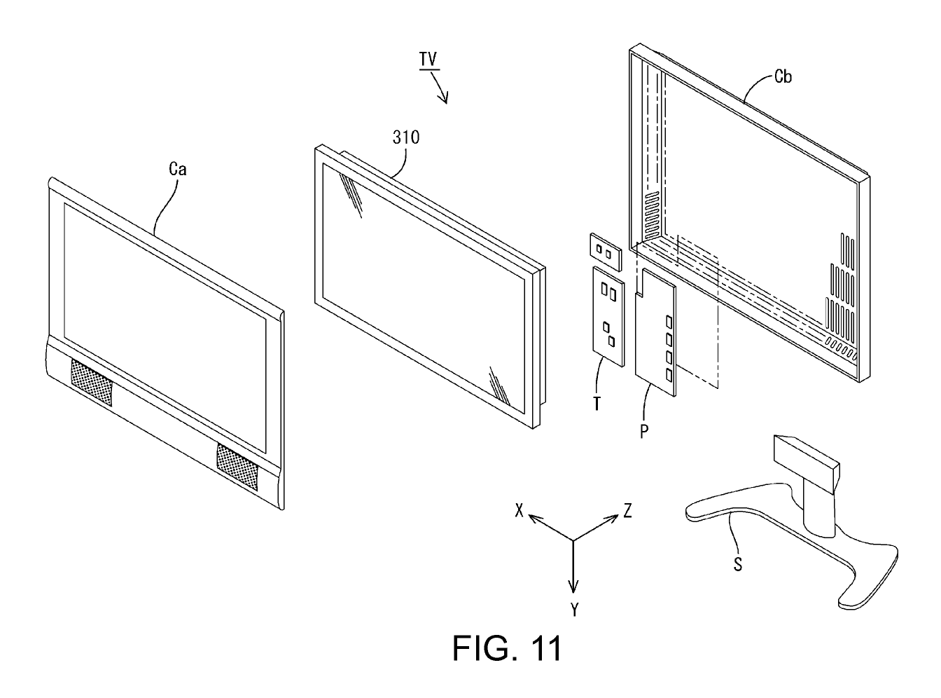

Embodiment 4 will be explained in detail with reference to figures. Embodiment 4 illustrates an example of a television-receiving device TV. Here, a liquid crystal device 310 in FIG. 11 has an identical configuration with the liquid crystal display device 10 in Embodiment 1. The present configuration includes both front and rear cabinets Ca and Cb that house the liquid crystal display device 310 in a sandwiching manner, a power source P, a tuner T and a stand S for supporting the liquid crystal display device 310 in a prescribed direction. Even if the liquid crystal display device 310 is used as a display medium other than digital signage DS, it is possible this may be arranged in a direction different from a usual direction, thus it is useful to have a configuration in which each end of an optical sheet is locked against a frame. In a television receiver TV with such a configuration, according to the present embodiment, when the temporarily extended optical sheet contracts, each end of the optical sheet is returned to a locked state thereby preventing or suppressing formation of wrinkles or damages from occurring to the optical sheet.

Variations of the abovementioned respective embodiments are explained below.

(1) Although in the abovementioned respective embodiments, the configurations used as digital signage or a television receiver are exemplified, the configuration may be used as other display mediums.

(2) Although in the abovementioned respective embodiments, an edge-light type backlight device is exemplified, the backlight device may be a direct-type backlight device.

(3) Although in the abovementioned respective embodiments, the configuration in which the tab is provided on the end of the optical sheet and the opening is provided on the tab is exemplified, a configuration in which there is no tab on the end of the optical sheet and the opening made directly on the end of the optical sheet may be adopted.

(4) In addition to the abovementioned respective embodiments, the shape of the frame-shaped part, and the position of the locking member provided on the frame-shaped part can be modified as appropriate.

(5) In addition to the abovementioned respective embodiments, the shape, the arrangement, as well as the number of the locking members provided on each end of the frame-shaped part can be modified as appropriate.

(6) In addition to the abovementioned respective embodiments, the shape and the arrangement of the opening, as well as the number of the openings provided on the optical sheet can be modified as appropriate

(7) In the abovementioned respective embodiments, the liquid crystal display device using the liquid crystal panel is exemplified, however, the present invention is applicable to a display device using other types of display panels.

(8) In the abovementioned respective embodiments, the television receiver having a tuner is exemplified, the present invention is applicable to a display device that does not include a tuner.

Although the respective embodiments of the present invention are explained in detail, these embodiments are merely illustrative examples and do not limit the scope of claims. The features set forth in the scope of claims include various modifications and alternations of the specific embodiments exemplified above.

Further, technical elements explained in the present specification and drawings exhibit technical usefulness independently or in various combinations and are not limited to the combinations set forth in claims at the time of application. Moreover, the features exemplified in the present specification or drawings achieve multiple objectives simultaneously and achievement of one objective alone exhibits technical usefulness.

### DESCRIPTION OF REFERENCE CHARACTERS

DS digital signage

TV television receiver

Ca and Cb cabinet

T tuner

S stand

10 liquid crystal display device

12, 112, 212, 312, 412 bezel

14, 114, 214 frame

14a, 114a, 214a frame-shaped part

14b, 114b, 214b tubular frame part

15, 115, 215 locking member

15a, 115a, 214a penetrating part

15b, 115b, 215b extending part

15b1 first inclined surface

16 liquid crystal panel

18, 118, 218 optical sheet

183, 1183, 218e tab

18s, 118s, 218s opening

20 light guide plate

22 chassis

24, 124, 224, 324, 424 backlight device

26 reflective sheet

28 LED

30 LED substrate

32 LED unit

1. An illumination device, comprising:
a light source;
an optical sheet that exerts an optical effect on light emitted from said light source, said optical sheet forming a rectangular shape in a plan view and having an opening in each end on four sides thereof;
a support member having a frame shape and at least having a support surface that supports said ends of the optical sheet; and
locking members that regulate movement of the respective ends of the four sides of the optical sheet in a thickness direction thereof, each of said locking members comprising a penetrating part rising from said support surface of the support member toward said optical sheet and passing through the corresponding opening therein, and an extending part that extends from a top of said penetrating part in a direction away from a center position of said optical sheet along a sheet surface thereof, an extension length of said extending part being smaller than an opening width of said corresponding opening in the optical sheet, said extending part having cross-sections that are progressively larger from a tip of the extending part opposite to the top of the penetrating part toward a center of the extending part in at least a portion thereof adjacent to said tip.

2. The illumination device according to claim 1, wherein a surface of the extending part is curved.

3. The illumination device according to claim 1,
wherein the penetrating part rises at a right angle relative to the support surface of the support member, and
wherein the extending part extends at a right angle relative to said penetrating part.

4. The illumination device according to claim 1, wherein a gap between the extending part and the optical sheet is smaller than a thickness of the optical sheet.

5. The illumination device according to claim 1,
wherein tabs that protrude toward the direction away from the center position of the optical sheet are respectively provided on each end of the four sides of the optical sheet, and
wherein the opening is provided in the respective tabs.

6. The illumination device according to claim 1, further comprising:
a light guide plate having a light-receiving face on at least one end face thereof, and a light-exiting surface on one surface thereof, said light guide plate being arranged such that the light-receiving face opposes a light-emitting surface of the light source and the light-exiting surface faces the sheet surface of the optical sheet with a gap therebetween.

7. The illumination device according to claim 6, wherein said support member is interposed between the light guide plate and the optical sheet.

8. The illumination device according to claim 1, wherein the locking member is elastically deformable.

9. A display device, comprising:
the illumination device according to claim 1; and
a display panel that performs display with light from the illumination device.

10. The display device according to claim 9,
wherein the display panel is disposed on a side opposite to the support surface of the support member with the optical sheet therebetween, and
wherein said support member has a panel support surface that supports ends of the display panel.

11. The display device according to claim 10, wherein the display panel is disposed at a gap from the optical sheet by being supported by the panel support surface.

12. The display device according to claim 9, further comprising:
a bezel for pressing the ends of the display panel from a side opposite to the support member,
wherein the support member supports the bezel on a surface that is above the panel support surface, and
wherein the penetrating part extends to a height whereby the top of the penetrating part is positioned between the panel support surface and said surface that is above the panel support surface and supported by the bezel.

13. The display device according to claim 9, wherein the display panel is a liquid crystal panel having liquid crystal.

14. A television receiver, comprising:
the display device according to claim 9.
